(19) United States
(12) Patent Application Publication
(10) Pub. No.: US 2013/0288031 A1
(43) Pub. Date: Oct. 31, 2013

(54) FIRE RESISTANT PAINT, ARTICLES OF MANUFACTURE, AN APPARATUS FOR MANUFACTURE AND A PROCESS FOR MANUFACTURE THEREOF

(71) Applicant: Joseph Labock, Bat Yam (IL)

(72) Inventor: Joseph Labock, Bat Yam (IL)

(73) Assignee: L-M-J NATION SECURITY LLC, Wilmington, DE (US)

(21) Appl. No.: 13/818,691

(22) PCT Filed: May 28, 2012
(86) PCT No.: PCT/IB12/52662

§ 371 Date: Feb. 25, 2013

Related U.S. Application Data
(63) Continuation of application No. 13/134,052, filed on May 27, 2011, now abandoned.

(51) Int. Cl. C09D 5/18

(52) U.S. Cl. CPC C09D 5/185
USPC 428/215; 428/446; 428/451; 252/606

(57) ABSTRACT

A fire and heat resistant composition for providing or enhancing the fire resistance of a material. The composition consists of both chemical and physical integration. Physical application is a coating composition containing materials including a fire and heat resistance means, lower peak heat release means, lower heat released per unit time means, higher temperature gradient means, low flame spread means, high ignition delay means, low peak heat release means, low total heat release means, high thermal stability means, elastic and coating thickness encasement means and heat. Chemical applications consist of chemical additive which are naturally more fire safe.

### FIELD OF THE INVENTION

The present invention relates generally to fire resistant paint, articles of manufacture, an apparatus for manufacture and a process for manufacture thereof, and more specifically to fire resistant paint featuring a combination of chemical and physical components.

### BACKGROUND OF THE INVENTION

Many modern materials have important and desirable properties, yet may burn easily and may also give off toxic fumes when burning. Hence, much work is being done to find materials that are resistant to heat and flames, or that are otherwise “fire safe”. The effort, in the market place as well in labs, is to find effective low-level additives to further reduce ignitability, or the heat release rate. Current solutions feature different kinds of coating or insertion of additives to organic and non-organic polymers. However, neither method by itself is adequate.

U.S. Pat. No. 7,638,572 to Horley et al teaches a fire retardant coating that features a film forming polymer, an inorganic fire retardant material such as huntite, hydromagnesite, aluminum trihydroxide or magnesium hydroxide, and a metal stannate or metal hydroxyl stannate. However the composition relies on a simple coating which provides limited fire retardant ability.

### SUMMARY OF THE INVENTION

A fire and heat resistant composition for providing or enhancing the fire resistance of a material. The composition consists of both chemical and physical integration. The fire-resistant composition of the present invention consists of a new formula that has particularly remarkable fire resistance, and can be used in a wide range of applications.

By “fire resistant” it is also meant heat resistant; the terms are used interchangeably herein.

According to at least some embodiments, there is provided a fire resistant composition comprising an intumescent base material; a flame spread reduction material comprising one or more of a zinc compound, a borate, a phosphate, a silicate or an oxide, and optionally and preferably further comprises alumina trihydrate; an oxygen reduction agent, a thermal transmission reduction agent and refractory fibers.

The intumescent base material optionally comprises a charring agent, preferably further comprises a blowing agent and a foaming agent, more preferably further comprises a binding agent, and most preferably further comprises a solvent. A pigment may optionally also be present. According to a preferred embodiment of the present invention, the intumescent base material comprises a combination of a foaming agent, a blowing agent, a charring agent, a binding agent, a solvent and optionally a pigment. If present, the foaming agent is preferably present in an amount of 20% to 60%.

The foaming agent may optionally comprise chemical compounds or coated compounds that have a low water solubility such as ammonium phosphate or potassium tripolyphosphate. The blowing agent may optionally comprise compounds such as melamine, urea, dicyandiamide, guanidine, or glycine. The charring agent may optionally comprise compounds such as dipentaerythritol (DPE), chlorinated paraffin, pentaerythritol, polyurethane, resorcinol, inositol, polyalcohols, sorbitol, or dextrin. The binding agent may optionally comprise compounds such as calcium carbonate or butoxyethoxy ethanol. The solvent may optionally comprise water, oil, toluene, or propylene glycol. The pigment may optionally comprise compounds such as titanium oxide, lamp black or oxalates.

The flame spread reduction material optionally and preferably comprises one or more of a zinc compound such as a zinc oxide (ZnO), a zinc borate (3ZnO₂B₂O₃), or a zinc phosphate (such as a zinc metaphosphate), but may also (additionally or alternatively) comprise one or more of ammonium orthophosphate, an aluminum oxide such as aluminum oxide trihydrate (Al₂O₃.3H₂O), silicon dioxide, ferric oxide, sodium oxide, zirconium oxide (ZrO₂) beryllium oxide (BeO), manganese oxide (MNO), zinc oxide (ZnO), titanium oxide (TiO₂), tantalum oxide (TaO₂), sodium silicate (Na2 SiO3), calcium silicate (Ca2 SiO4), antimony oxide or potassium metaphosphate.

The oxygen reduction agent comprises one or more of urea (CON₂H₄), urea formaldehyde, dicyandiamide and melamine.

The thermal transmission reduction agent preferably comprises an oxide and is more preferably selected from the group consisting of zirconium dioxide (ZrO₂), chromium oxide (CrO), yttrium oxide (Y₂O₃), and potassium oxide (K₂O).

The refractory fibers preferably comprise physical fibers which comprise a flame reduction agent. The fibers optionally and preferably have a size of from 1 micron to 100 millimeter, more preferably from 10 microns to 10 millimeter and most preferably between 100 microns to 1 millimeter. The size of the fiber may optionally be determined according to the form of application; for example if the composition is to be applied by a spray of some type, preferably the fibers are smaller (in the micron range). Similarly, smaller fibers may be preferred (again in the micron range) if the physical appearance of the composition after application to an object or structure is important. Preferably the fibers comprise a suitable oxide, which more preferably is selected from the group consisting of aluminum oxide (Al₂O₃), silicon dioxide (SiO₂), ferric oxide (Fe₂O₃), sodium oxide (Na₂O), zirconium oxide (ZrO₂) beryllium oxide (BeO), manganese oxide (MNO), zinc oxide (ZnO), titanium oxide (TiO₂) and tantalum oxide (TaO₂).

According to at least some embodiments, the intumescent base material is present in an amount of 20% to 60% weight/weight percent of the total composition (all percentages given herein are weight per weight over the total composition unless otherwise indicated); the flame spread reduction material is present in an amount of 2% to 12%; the oxygen reduction agent is present in an amount of 1% to 5%; the thermal transmission reduction agent is present in an amount of 2% to 6%; and the refractory fibers are present in an amount of 8% to 18%.

The flame resistant composition optionally and preferably comprises one or more of a stabilizer and a mechanical enhancer. The stabilizer more preferably also reduces volatility of any organic agents present in or near the composition, most preferably featuring one or both of erythritol or paraffin. The stabilizer is optionally and preferably present in an amount of 6% to 12%.

The mechanical enhancer optionally and preferably comprises one or more materials for physical impact resistance and adhesion to a substrate, including but not limited to calcium carbonate (CaCO₃), ceramic oxides, calcium silicate, and sodium silicate. The mechanical enhancer is optionally and preferably present in an amount of 1% to 4%.

The flame resistant composition optionally and preferably comprises an elasticity agent, which more preferably comprises one or more of vermiculite, perlite elastomerics, and acrylics. The elasticity agent may optionally be added in an amount that is suitable for spraying, painting, dripping, coating or otherwise applying the composition, which is preferably up to 20% of the composition.

The intumescent composition may also optionally further comprise a ceramic additive, such as ceramic microspheres for example, as a fine powder blend of high strength ceramic microspheres.

According to at least some embodiments, for example and without limitation, for applications of the composition outdoors (i.e.—outside of a building or other enclosure), the flame resistant composition further comprises a water-resistance agent and an efflorescence reduction agent, which may optionally be the same agent. When combined the agent is optionally and preferably selected from the group consisting of carboxymethyl cellulose, ethyl hydroxyethyl cellulose ammonium polyphosphate (NH4 H2 PO4), melamine-formaldehyde coatings, and other low solubility coatings and acrylics, silicones, diethylene glycol, and monoethyletheracetate. The water-resistance agent is optionally and preferably present in an amount of 4% to 8%.

According to at least some other embodiments, there is provided a fire resistant base composition comprising an intumescent base material, which may optionally be similar or identical to the previously described intumescent base material (but may also optionally be different as described below) and refractory fibers as previously described. The base composition optionally further comprises one or more of mineral powder such as granite powder (sheet silicate mineral, iron pyrite), ceramics (including particles, sheets and so forth), or a lead composition.

The lead composition preferably comprises a lead powder, which is more preferably a mixture of lead and a lead oxide. The lead composition may optionally further comprise a polymer, such as polytetrafluoroethylene (PTFE), which acts as a binder, or any other suitable binder, such that the powder forms a solid composition. Other non-limiting examples of suitable binders include water glass; various emulsions of plastics, polysaccharides and other polymers; and/or polyvinyl alcohol and other aqueous binders as are known in the art.

Optionally, rather than combining the lead composition with the base composition, the lead composition may be applied as a separate layer of material, for example optionally in the form of lead loaded plastic. Lead loaded plastic may optionally be formed for example when lead powder incorporated into a plasticizer is added to plastics; the lead loaded plastic may then be formed into sheets.

Also optionally, according to some embodiments, the lead composition is combined with the fire resistant composition as described above, in addition to or in place of combining it with the fire resistant base composition.

According to at least some embodiments, the intumescent base material for the fire resistant base composition may optionally comprise 10% to 40% foaming agent, which is optionally less than the amount present in the intumescent base material for the fire resistant composition. The intumescent base material for the fire resistant base composition may optionally comprise a foaming agent which is preferably a phosphate, such as mono-ammonium phosphate, diammonium phosphate, ammonium polyphosphate or potassium triphosphate.

The intumescent base material may further comprise a charring agent which is dipentaerythritol (DPE), polyol, or chlorinated paraffin, or combinations thereof, which is more preferably present in an amount of 4% to 35%.

The intumescent base material may further comprise a blowing agent gas source, which is preferably melamine resin, urea, or dicyandiamide, or combinations thereof, and which is more preferably present in an amount of 5% to 35%.

The intumescent base material may further comprise a film-forming binder, which is preferably polyvinyl acetate, acrylic resin, vinyl acrylic resin, silicone resin, epoxy, or polyurethane, or combinations thereof, and which is more preferably present in an amount of 1% to 50%.

The intumescent base material may further comprise a solvent, which is preferably one or more of water, alcohols, napthas, or aromatic hydrocarbons, or combinations thereof, in sufficient amount to produce a fluid consistency, and which is more preferably present in an amount of 10% to 60%.

The intumescent base material may further comprise one or more pigments, which are preferably one or more of Tio2, ZnO, silicates, carbon black, lamp black, phthalocyanine blue or green and which are more preferably present in an amount of 0% to 40%.

The intumescent base material may further comprise one or more fillers, which are preferably one or more of CaCO₃ or a mineral such as a baryte, or combination thereof. However, the intumescent base material preferably lacks lead for this outer layer and may also optionally lack lead in the base layer.

According to at least some embodiments, the refractory fibers dispersed within the base composition preferably comprise an oxide, which is more preferably selected from the group consisting of aluminum oxide (Al₂O₃), silicon dioxide (SiO2), ferric oxide (Fe2 O3), titanium dioxide (TiO2), potassium oxide (KO2), sodium oxide (Na2O), and zirconium oxide (ZrO2) or a combination thereof. More preferably, the oxide comprises a combination of aluminum oxide (Al₂O₃) silicon dioxide (SiO2), and most preferably comprises at least one more oxide selected from the group consisting of ferric oxide (Fe2 O3), titanium dioxide (TiO2), potassium oxide (KO2), sodium oxide (Na2 O), and zirconium oxide (ZrO2).

Optionally and more preferably, these compounds, when present, are present in the following amounts: aluminum oxide (Al2 O3) in the range of 40% to 55% by weight, silicon dioxide (SiO2) in the range of 40% to 55% by weight; ferric oxide (Fe2 O3), titanium dioxide (TiO2), potassium oxide (KO2), sodium oxide (Na2 O), and zirconium oxide (ZrO2), present in the range of 0.1% to 5.0% by weight.

According to at least some embodiments, the fire resistant base composition is preferably applied to a structure or physical object, followed by the fire resistant composition, such that of the two compositions, the fire resistant base composition is preferably applied first. According to at least some embodiments, optionally each composition is applied in a thickness in a range of from about 0.050 inch to about 0.50 inch.

Optionally, an additional layer is present below the fire resistant composition, which is optionally and preferably applied above the fire resistant base composition but below the fire resistant composition. The additional layer preferably comprises silicone and more preferably one component silicone. The silicone is optionally in the form of a rubber or resin. The silicone (polymerized siloxane) may optionally comprise any suitable siloxane polymer material.

The silica polymer may optionally comprise any type of silica containing polymer, but preferably includes a polymerized siloxane (silicone, also referred to herein as a siloxane polymer), including without limitation a derivatized silica polymer or a derivatized silicone, which may optionally be further derivatized with one or more hydrophobic groups, including but not limited to methyl groups and silyl groups. The methyl groups may optionally be present such that the siloxane polymer comprises a polymethylsiloxane, a polydimethylsiloxane, or a polytrimethylsiloxane. The silyl groups are preferably a methyl silyl group, such as for example and without limitation, trimethylsilyl and/or dimethylsilyl and/or monomethylsilyl groups. Optionally, the siloxane polymer comprises a polydimethylsiloxane and is present in a composition which further comprises amorphous silica and a crosslinker, optionally and preferably with one or more fillers and/or additives.

The present invention, in various embodiments as described herein, is preferably applied to a physical structure so as to form a structure comprising a plurality of layers of composite material which integrate to provide predetermined load-behavior characteristics such as lower peak heat release rates, lower heat released per unit time, higher temperature gradient, low flame spread, high ignition delay, low peak heat release, low total heat release, high thermal stability, heat sink effect, a reduced amount of smoke and heat reflective property.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 shows an exemplary embodiment in which the apparatus operates on material that is not silicone-coated or that is already silicone-coated before the process of application of the coatings according to various embodiments of the present invention starts; and

FIG. 2 shows an exemplary embodiment in which the apparatus performs silicone-coating of the material as an integral part of the coating process.

### DETAILED DESCRIPTION OF THE INVENTION

According to the invention, it has been discovered that a fire-resistant barrier can be constructed by incorporating physical and chemical treatments. The structure is comprised of a plurality of layers of composite material which is integrated to provide predetermined load-behavior characteristics.

According to at least some embodiments, there is provided a fire resistant composition comprising an intumescent base material; a flame spread reduction material comprising one or more of a zinc compound, a borate, a phosphate, a silicate or an oxide, and optionally and preferably further comprises alumina trihydrate; an oxygen reduction agent, a thermal transmission reduction agent and refractory fibers.

Optionally according to at least some embodiments, there is provided a base layer for being placed on a physical surface before the above fire resistant composition is applied, comprising the intumescent base material of the fire resistant coating, and optionally one or more of mineral powder such as granite powder (sheet silicate mineral, iron pyrite), or a lead composition.

Optionally, an additional layer is present below the fire resistant composition, which is optionally and preferably applied above the fire resistant base composition but below the fire resistant composition. The additional layer preferably comprises silicone and more preferably one component silicone. The silicone is optionally in the form of a rubber or resin. The silicone (polymerized siloxane) may optionally comprise any suitable siloxane polymer material.

The present invention will be more fully understood from the following detailed description of the preferred embodiments thereof, taken together with the drawings.

In the detailed description, numerous specific details are set forth in order to provide a thorough understanding of the invention. However, it will be understood by those skilled in the art that these are specific embodiments and that the present invention may be practiced also in different ways that embody the characterizing features of the invention as described and claimed herein.

In the following detailed description, numerous specific details are set forth in order to provide a thorough understanding of some embodiments of the invention. However, it will be understood by persons of ordinary skill in the art that some embodiments may be practiced without these specific details. In other instances, well-known methods, procedures, components, units and/or circuits have not been described in detail so as not to obscure the discussion.

The terms “plurality” or “a plurality” as used herein include, for example, “multiple” or “two or more”. For example, “a plurality of items” includes two or more items.

### Example 1

### Application to Wood

A fire-retardant coating material was prepared that included a fluid intumescent material (a non-limiting example of the intumescent base). The fluid intumescent material included a foaming agent; a blowing agent gas source selected from the group consisting of melamine, urea, dicyandiamide, guanidine and glycine; a charring agent, a film-forming binder, a solvent and, in some cases, a pigment or filler. Half a gallon of the intumescent material was mixed with 8 ounces of refractory fibers, which in this non-limiting example comprised 3 ounces of milled fiber and 5 ounces of short strand fibers. The fibers comprised aluminum oxide (about 50% of the total fibers weight per weight), silicon dioxide (about 50%), ferric oxide (about 0.15%), titanium dioxide (about 0.15%), potassium oxide (about 0.15%), sodium oxide (about 0.2%) and zirconium oxide (about 0.2%). This combination was mixed with 16 ounces of granite powder and applied as a coating to one side of a wood sample of the size of 20×20 centimeters.

Next a layer of a one component, water-based, caulking grade, general purpose fire resistant sealant in the form of silicone resin was applied to the coated wood.

After curing a layer of the fire resistant composition according to at least some embodiments of the present invention was applied.

The coating of the fire resistant composition was applied to a thickness of 0.250 inches in this non-limiting example; however, optionally the composition is applied in a thickness in a range of from about 0.050 inch to about 0.50 inch.

A propane torch, having a temperature of 2600 F, was applied to the surface of the wood sample covered with the composition for one (1) hour. The inner layer was shown to be unaffected; the outer layer swelled and bubbled, thereby forming a protective layer that protects the inner layer.

During this heating process, it was possible to place a hand behind the material which had a cool temperature to the touch, such that no heat or flames affected the other side of the wood. It was determined that the wood was able to resist the fire and the heat for the time of the test and was sufficiently insulated from the heat to protect both the wood material and anything behind the wood material as a barrier.

Based upon various tests with wood, it has been determined that when heat is applied to the coated wood at a temperature in the range of from 1200 to 4000°, the coating composition swells to 5 to 12 times the original thickness of the coating, while the wood remains protected. Similar results, in terms of the maximum temperature range, were found for fabric, wood and cardboard, as described below.

### Example 2

### Coated Fabric

The same composition of Example 1 was applied to one side of a fabric article, featuring two pieces of heavy duty plain woven fabric attached together with fire related silicone sealant in which the coating was applied at the same thickness as for the wood in Example 1. The fabric tested was a Pyroblanket (ADL Insulflex Inc), although optionally canvas, fiberglass (optionally coated), Kevlar, mineral impregnated or coated fabric, aluminum and other sheet metal fabrics may be used, additionally or alternatively. The silicone sealant tested was Metacaulk 1000 (Rectorseal).

A propane torch, at a temperature of 1300 F, was applied to the coated fabric for 17 minutes. Again, while the coating bubbled and swelled, the fabric maintained its integrity and was cool to the touch on the side away from the flame. The coated fabric was found to withstand a similar temperature range as for wood in Example 1.

### Example 3

### Cardboard

The same composition of Example 1 was applied to one side of a piece of cardboard at the same thickness as for the wood in Example 1. A propane torch, at a temperature of 1300 F, was applied to the coated cardboard for 12 minutes. Again, while the coating bubbled and swelled, the fabric maintained its integrity and was cool to the touch on the side away from the flame. The coated fabric was found to withstand a similar temperature range as for wood in Example 1.

### Example 4

### Drywall

The same composition of Example 1 was applied to one side of a piece of drywall at the same thickness as for the wood in Example 1. A propane torch, at a temperature of 2600 F, was applied to the coated drywall for 90 minutes. Again, while the coating bubbled and swelled, the drywall maintained its integrity and was cool to the touch on the side away from the flame. The coated drywall was found to withstand a similar temperature range as for wood in Example 1.

### Example 5

### Fabric Case

A fabric case was made from plain-woven heavy-duty pieces of fabric, again attached with Fire Rated Silicone Sealant to form a case in a shape of a box in the size of 20×10×20 centimeters. Inside the box was placed Styrofoam in the size of 3×3×3 cube, a cell phone battery and two AA energizer batteries. The box was sealed and exposed to open flame produced by igniting gasoline in an open bath made out of metal in the size of 60×60 centimeters. The temperature of the flame was measured to be 640C. After 15 minutes the objects were removed from the case. The materials that were placed inside the case were protected from the flames and the heat; no charring or heat or fire damage was observed, and the batteries were found to be fully functional.

### Example 6

### Machine for Applying Coating(s)

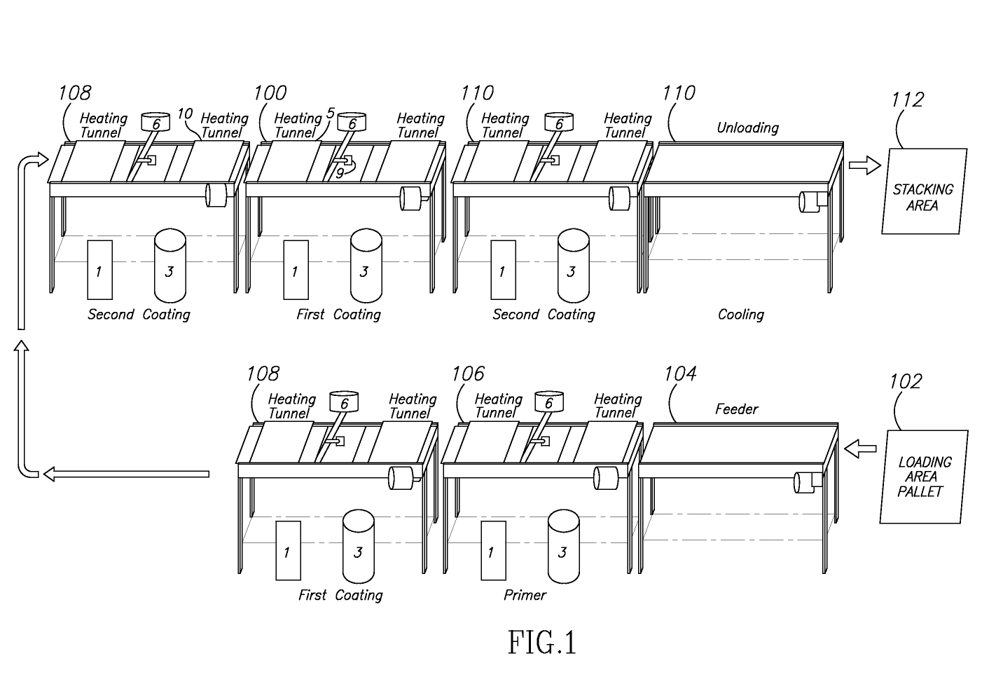

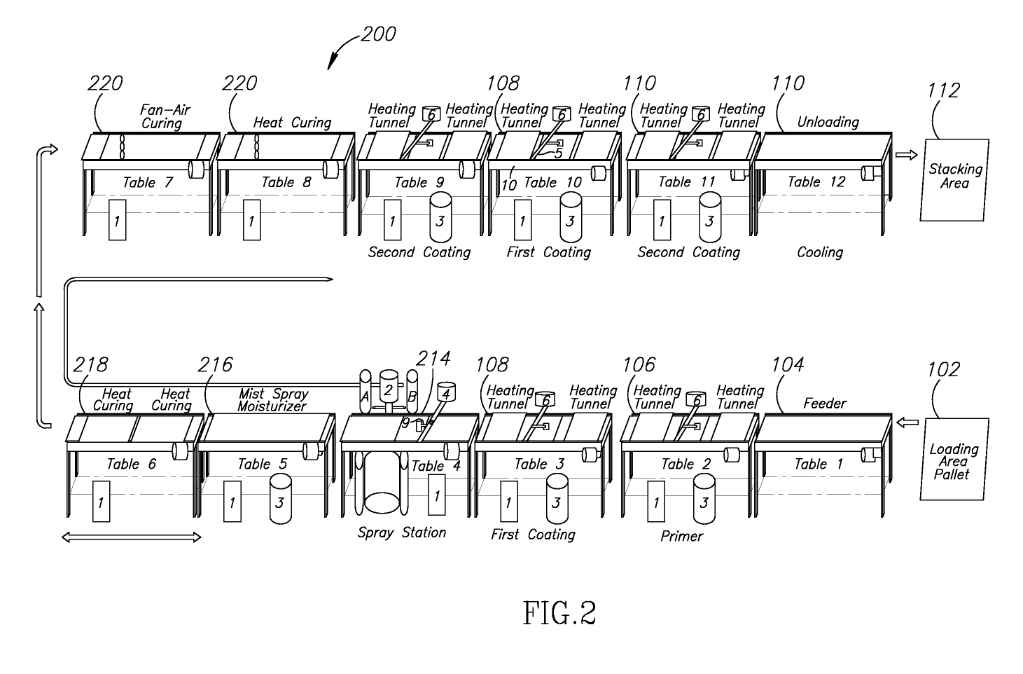

FIGS. 1 and 2 show different embodiments of machines according to various embodiments of the present invention for applying the coating(s) described above. FIG. 1 shows an exemplary embodiment in which the apparatus operates on material that is not silicone-coated or that is already silicone-coated before the process of application of the coatings according to various embodiments of the present invention starts. FIG. 2 shows an exemplary embodiment in which the apparatus performs silicone-coating of the material as an integral part of the coating process.

As shown in FIG. 1, a coating apparatus 100 features a loader 102 for receiving physical articles to be coated, which in turn provides the articles to a feeder 104. Primer is then applied at a priming table 106, which preferably features an electronic control unit 1 and a pressure tank 3 for holding the priming material. The priming material is applied to the article by a spray unit 6, which comprises a motor drive (not shown) for moving spray unit 6 over the surface to be sprayed. Optionally spray unit 6 features two spray heads 5, one of which optionally and preferably sprays material while the other of which preferably acts to cure the sprayed material. Priming table 106 also features two heating tunnels 10 for more even heating of the sprayed material, although optionally only one heating tunnel 10 may be provided.

After priming, the article optionally passes to at least one fire resistant base coating table 108 and optionally two such tables 108 as shown; more tables could optionally be implemented for multiple base coatings (not shown). Again, fire resistant base coating table 108 features similar components to priming table 106, for spraying the base coating on the article and for heating it.

After application of the base, the article passes to at least one fire resistant composition coating table 110 and optionally two such tables 110 as shown; more tables could optionally be implemented for multiple base coatings (not shown). Again, fire resistant composition coating table 110 features similar components to priming table 106, for spraying the base coating on the article and for heating it.

Next the article passes to a cooling table 112 and is then unloaded.

FIG. 2 shows an apparatus 200 which is another embodiment of an apparatus for applying coatings according to various embodiments of the present invention. Components with the same number as FIG. 1 have the same or similar function.

The process for operating apparatus 200 of FIG. 2 is very similar to that of FIG. 1, except that after the first base coating table 108, the article is preferably passed to a silicone coating table 214, for coating the initially coated article with a layer of silicone. Silicone coating table 214 features at least one silicone pump 2 and preferably two silicone pumps 2 (shown as A and B) for pumping silicone onto the article. The silicone is pumped from each silicone pump 2 to a spray gun 9 through a silicone gun applicator bridge 8. A motor drive 4 ensures that the spray gun 9 is moved evenly over the article that is being sprayed.

The article then moves to a moisturizing spray table 216 for applying moisture for steaming with heating, after which the article is cured on a curing table 218. The temperature for curing in this example was 60-70 C and also featured blown dry air; however, optionally curing may take place at a range of 40-90 C. Silicone coatings may for example take 16 minutes to cure; again optionally any of these coatings may be applied as a pre-formed layer. After that the article is moved to one or more air-curing (air-drying) tables 220, which direct a flow of blown air onto the article. The remaining tables and processes occur as for FIG. 1.

The references cited herein teach many principles that are applicable to the present invention. Therefore the full contents of these publications are incorporated by reference herein where appropriate for teachings of additional or alternative details, features and/or technical background.

It is to be understood that the invention is not limited in its application to the details set forth in the description contained herein or illustrated in the drawings. The invention is capable of other embodiments and of being practiced and carried out in various ways. Those skilled in the art will readily appreciate that various modifications and changes can be applied to the embodiments of the invention as hereinbefore described without departing from its scope, defined in and by the appended claims. Furthermore, any combinations of embodiments or sub-embodiments may optionally be made and are considered within the scope of the present invention.

1. A fire resistant composition comprising an intumescent base material, wherein said intumescent base material further comprises a blowing agent and a foaming agent, wherein said foaming agent is present in an amount of 20% to 60% and wherein said foaming agent comprises ammonium phosphate, and wherein said blowing agent comprises melamine; a flame spread reduction material, wherein said flame spread reduction material comprises sodium silicate (Na2 SiO3); an oxygen reduction agent wherein said oxygen reduction agent comprises urea formaldehyde, a thermal transmission reduction agent comprising zirconium oxide and a plurality of refractory fibers wherein said fibers comprise physical fibers comprising titanium oxide (TiO₂), the composition further comprising a charring agent, said charring agent comprising dipentaerythritol (DPE); a mechanical enhancer, said mechanical enhancer comprising a ceramic oxide; a stabilizer, said stabilizer comprising one or both of paraffin or erythritol; and further comprising an elasticity agent, wherein said elasticity agent comprises one or more of vermiculite, perlite elastomerics, and acrylics.

2. The composition of claim 1, further comprising alumina trihydrate.

3. (canceled)

4. The composition of claim 1, wherein said charring agent further comprises one or more of chlorinated paraffin, pentaerythritol, polyurethane, resorcinol, inositol, polyalcohols, sorbitol, or dextrin, or a combination thereof.

5. (canceled)

6. (canceled)

7. (canceled)

8. The composition of claim 1, wherein said blowing agent further comprises one or more of, urea, dicyandiamide, guanidine, or glycine, or a combination thereof.

9. The composition of claim 1, wherein said intumescent base material further comprises a binding agent.

10. The composition of claim 9, wherein said binding agent comprises calcium carbonate or butoxyethoxy ethanol.

11. The composition of claim 1, wherein said intumescent base material further comprises a solvent.

12. The composition of claim 11, wherein said solvent comprises water, oil, toluene, or propylene glycol.

13. (canceled)

14. The composition of claim 1, wherein said intumescent base material further comprises a pigment.

15. The composition of claim 14, wherein said pigment comprises one or more of titanium oxide, lamp black or oxalates, or a combination thereof.

16. (canceled)

17. (canceled)

18. The composition of claim 1, wherein said flame spread reduction material further comprises one or more of ammonium orthophosphate, an aluminum oxide, silicon dioxide, ferric oxide, sodium oxide, beryllium oxide (BeO), manganese oxide (MNO), tantalum oxide (TaO₂), calcium silicate (Ca2 SiO4), antimony oxide or potassium metaphosphate.

19. The composition of claim 18, wherein said aluminum oxide comprises aluminum oxide trihydrate (Al₂O₃.3H₂O).

20. (canceled)

21. (canceled)

22. (canceled)

23. (canceled)

24. The composition of claim 1, wherein said fibers have a size of from 1 micron to 100 millimeter.

25. The composition of claim 24, wherein said fibers have a size of from 10 microns to 10 millimeter.

26. The composition of claim 25, wherein said fibers have a size of from 100 microns to 1 millimeter.

27. (canceled)

28. (canceled)

29. The composition of claim 1, wherein the intumescent base material is present in an amount of 20 to 60 percent of the total weight of the composition.

30. The composition of claim 1, wherein the flame spread reduction material is present in an amount of 2% to 12%.

31. The composition of claim 1, wherein the oxygen reduction agent is present in an amount of 1% to 5%.

32. The composition of claim 1, wherein the thermal transmission reduction agent is present in an amount of 2% to 6%.

33. The composition of claim 1, wherein the refractory fibers are present in an amount of 8% to 18%.

34. (canceled)

35. (canceled)

36. (canceled)

37. The composition of claim 1, wherein said stabilizer is present in an amount of 6% to 12%.

38. (canceled)

39. The composition of claim 1, wherein said mechanical enhancer comprises one or more of calcium carbonate (CaCO₃), calcium silicate, and sodium silicate.

40. The composition of claim 39, wherein said mechanical enhancer mechanical enhancer is optionally and preferably present in an amount of 1% to 4%.

41. (canceled)

42. (canceled)

43. The composition of claim 1, wherein said elasticity agent is present in an amount of up to 20%.

44. (canceled)

45. The composition of claim 1, further comprising a water-resistance agent and an efflorescence reduction agent.

46. The composition of claim 45, wherein said water-resistance agent and said efflorescence reduction agent are the same agent.

47. The composition of claim 46, wherein said combined agent is selected from the group consisting of carboxymethyl cellulose, ethyl hydroxyethyl cellulose ammonium polyphosphate (NH4 H2 PO4), melamine-formaldehyde coatings, acrylics, silicones, diethylene glycol, and monoethyletheracetate.

48. The composition of claim 46, wherein said combined agent is present in an amount of 4% to 8%.

49. The composition of claim 1, further comprising a lead composition.

50. The composition of claim 49, wherein said lead composition comprises a lead powder.

51. The composition of claim 50, wherein said lead powder is a mixture of lead and a lead oxide.

52. The composition of claim 51, wherein said lead composition further comprises a binder selected from the group consisting of a polymer, water glass, an emulsion of a plastic, an aqueous binder or polyvinylalcohol, such that the powder forms a solid composition.

53. The composition of claim 52, wherein said polymer comprises polytetrafluoroethylene (PTFE) or a poly saccharide.

54-83. (canceled)

84. A structure or physical object, comprising a layer of said fire resistant base composition of claim 1.

85. The structure or physical object of claim 84, further comprising a layer of said fire resistant composition of claim 1, such that of the two compositions, the fire resistant base composition is applied first.

86. The structure or physical object of claim 85, wherein each composition is applied in a thickness in a range of from about 0.050 inch to about 0.50 inch.

87. The structure or physical object of claim 86, further comprising an additional layer applied above the fire resistant base composition but below the fire resistant composition.

88. The structure or physical object of claim 87, wherein said additional layer comprises silicone.

89. The structure or physical object of claim 88, wherein said additional layer comprises one component silicone.

90. The structure or physical object of claim 89, wherein said silicone is in the form of a rubber or resin.

91. The structure or physical object of claim 90, wherein said silicone comprises a siloxane polymer or a silica polymer.

92. The structure or physical object of claim 91, wherein said silicone comprises a derivatized silica polymer or a derivatized silicone.

93. The structure or physical object of claim 92, wherein said derivatized silica polymer or said derivatized silicone is derivatized with one or more hydrophobic groups.

94. The structure or physical object of claim 93, wherein said hydrophobic groups comprise one or more of methyl groups and silyl groups.

95. The structure or physical object of claim 94, wherein said methyl groups are present such that the siloxane polymer comprises a polymethylsiloxane, a polydimethylsiloxane, or a polytrimethylsiloxane.

96. The structure or physical object of claim 94, wherein said silyl groups comprise trimethylsilyl and/or dimethylsilyl and/or monomethylsilyl groups.

97. The structure or physical object of claim 88, wherein the siloxane polymer comprises a polydimethylsiloxane and is present in a composition which further comprises amorphous silica and a crosslinker.

98. The structure or physical object of claim 84, wherein said base composition does not comprise a lead composition and wherein said lead composition is applied as a separate layer of material after said base composition.

99. The structure or physical object of claim 98, wherein said lead composition is in the form of lead loaded plastic.

100. The structure or physical object of claim 99, wherein said lead loaded plastic comprises lead powder incorporated into a plasticizer.
